(19) United States
(12) Patent Application Publication
(10) Pub. No.: US 2025/0062331 A1
(43) Pub. Date: Feb. 20, 2025

(54) ACTIVE ELECTRODE MATERIAL

(71) Applicant: Echion Technologies Limited, Cambridge (GB)

(72) Inventors: Peter Slater, Birmingham (GB); Daniel Martin, Cambridge (GB); Alexander Groombridge, Cambridge (GB)

(73) Assignee: Echion Technologies Limited, Cambridge (GB)

(21) Appl. No.: 18/722,526

(22) PCT Filed: Dec. 14, 2022
(86) PCT No.: PCT/GB2022/053230

§ 371 Date: Jun. 20, 2024

(30) Foreign Application Priority Data
Dec. 21, 2021 (GB) 2118598.8
Feb. 10, 2022 (GB) 2201717.2

(51) Int. Cl. H01M 4/485; H01M 4/02; H01M 4/58; H01M 10/0525

(52) U.S. Cl. CPC H01M 4/485; H01M 4/5825; H01M 10/0525; H01M 2004/021

(57) ABSTRACT

The invention relates to electrodes comprising a mixed niobium oxide as an active electrode material. The electrodes may be used in metal-ion batteries such as lithium-ion batteries. The mixed niobium oxide may have the formula M^{I}ₓ₋ᵤM^{y}_{(x/(5-y))}M^{V}_{z}Nb_{100-(x/(5-y))-z}O_{250-u/2}, wherein: M^{I} is a cation having an oxidation state of 1; M^{y} is a cation having an average oxidation state of y; M^{V} is a cation having an average oxidation state of 5; 1≤y≤4; 0.5≤x≤6; 0≤z≤10; 0≤u≤5; x>u.

### FIELD OF THE INVENTION

The present invention relates to active electrode materials, methods for the manufacture of active electrode materials, and electrodes comprising active electrode materials. Such materials are of interest as active electrode materials in metal-ion batteries, such as lithium-ion or sodium-ion batteries, for example as anode materials.

### BACKGROUND

Lithium-ion (Li-ion) batteries are a commonly used type of rechargeable battery with a global market predicted to grow to $200bn by 2030. Li-ion batteries are the technology of choice for electric vehicles that have multiple demands across technical performance to environmental impact, providing a viable pathway for a green automotive industry.

A typical lithium-ion battery is composed of multiple cells connected in series or in parallel. Each individual cell is usually composed of an anode (negative polarity electrode) and a cathode (positive polarity electrode), separated by a porous, electrically insulating membrane (called a separator), immersed into a liquid (called an electrolyte) enabling lithium ions transport.

In most systems, the electrodes are composed of an active electrode material-meaning that it is able to chemically react with lithium ions to store and release them reversibly in a controlled manner-mixed if necessary with an electrically conductive additive (such as carbon) and a polymeric binder. A slurry of these components is coated as a thin film on a current collector (typically a thin foil of copper or aluminium), thus forming the electrode upon drying.

In the known Li-ion battery technology, the safety limitations of graphite anodes upon battery charging is a serious impediment to its application in high-power electronics, automotive and industry. Among a wide range of potential alternatives proposed recently, lithium titanate (LTO) and mixed niobium oxides are the main contenders to replace graphite as the active material of choice for high power, fast-charge applications.

Batteries relying on a graphitic anode are fundamentally limited in terms of charging rate. Under nominal conditions, lithium ions are inserted into the anode active material upon charging. When charging rate increases, typical graphite voltage profiles are such that there is a high risk that overpotentials lead to the potential of sites on the anode to become <0 V vs. Li/Li+, which leads to a phenomenon called lithium dendrite electroplating, whereby lithium ions instead deposit at the surface of the graphite electrode as lithium metal. This leads to irreversible loss of active lithium and hence rapid capacity fade of the cell. In some cases, these dendritic deposits can grow to such large sizes that they pierce the battery separator and lead to a short-circuit of the cell. This can trigger a catastrophic failure of the cell leading to a fire or an explosion. Accordingly, the fastest-charging batteries having graphitic anodes are limited to charging rates of 5-7 C, but often much less.

Lithium titanate (LTO) anodes do not suffer from dendrite electroplating at high charging rate thanks to their high potential (1.6 V vs. Li/Li+), and have excellent cycle life as they do not suffer from significant volume expansion of the active material upon intercalation of Li ions due to their accommodating 3D crystal structure. LTO cells are typically regarded as high safety cells for these two reasons. However, LTO is a relatively poor electronic and ionic conductor, which leads to limited capacity retention at high rate and resultant power performance, unless the material is nanosized to increase specific surface area, and carbon-coated to increase electronic conductivity. This particle-level material engineering increases the porosity and specific surface area of the active material, and results in a significantly lower achievable packing density in an electrode. This is significant because it leads to low density electrodes and a higher fraction of electrochemically inactive material (e.g. binder, carbon additive), resulting in much lower gravimetric and volumetric energy densities.

A key measure of anode performance is the electrode volumetric capacity (mAh/cm³), that is, the amount of electric charges (that is lithium ions) that can be stored per unit volume of the anode. This is an important factor to determine the overall battery energy density on a volumetric basis (Wh/L) when combined with the cathode and appropriate cell design parameters. Electrode volumetric capacity can be approximated as the product of electrode density (g/cm³), active material specific capacity (mAh/g), and fraction of active material in the electrode. LTO anodes typically have relatively low specific capacities (c. 165 mAh/g, to be compared with c. 330 mAh/g for graphite) which, combined with their low electrode densities (typically <2.0 g/cm³) and low active material fractions (<90%) discussed above, lead to very low volumetric capacities (<300 mAh/cm³) and therefore low battery energy density and high $/kWh cost in various applications. As a result, LTO batteries/cells are generally limited to specific niche applications, despite their long cycle life, fast-charging capability, and high safety.

Mixed niobium oxides have been known in academic literature for some time. Recently, some mixed niobium oxides have been of interest for use in Li-ion cells. For example, Zhu et al., J. Mater. Chem. A, 2019, 7, 25537 and Zhu et al., Chem. Commun., 2020, 56, 7321-7324 disclose Zn₂Nb₃₄O₈₇ and Cu₂Nb₃₄O₈₇ as possible active electrode materials. These papers rely on complex particle-level engineering to purportedly achieve good properties, e.g. attempting to control particle porosity and morphology. WO2021/074593 and WO2021/074594 disclose various substituted and/or oxygen-deficient mixed niobium oxides which were found to have good properties for use as active electrode materials. However, there remains a need to identify further mixed niobium oxides with good properties for use as active electrode materials, in particular with good properties for use in Li-ion cells intended for high-power/fast-charging applications. Identifying such materials e.g. without the need for extensive particle-level engineering and/or without coatings is an important step to low-cost battery materials for mass market uptakes.

### SUMMARY OF THE INVENTION

In a first aspect, the invention provides an electrode comprising a mixed niobium oxide as an active electrode material, wherein the mixed niobium oxide has the formula M^{I}ₓ₋ᵤM^{y}_{(x(5-y))}M^{V}_{z}Nb_{100-(x/(5-y))-z}O_{250-u/}2 as defined in the claims.

The mixed niobium oxide may also have the formula BₐM^{V}_{z}Nb_{100-a-z}O₂₅₀₋ₐ as defined in the claims.

The mixed niobium oxide may also have the formula M_{b}Nb_{100-b}O_{250-2.5b+bc} as defined in the claims.

The inventors have found that electrodes according to the first aspect retain a surprisingly high capacity even when delithiated at high rates of e.g. 5C and 10C, as shown by the present examples. These are important results in demonstrating the advantages of the mixed niobium oxides of the invention for use in high-power batteries designed for fast charge/discharge.

In a second aspect, the invention provides a metal-ion battery comprising a mixed niobium oxide as an active electrode material, wherein the mixed niobium oxide is as defined in the first aspect. Optionally the metal-ion battery is a lithium-ion battery or a sodium-ion battery, preferably a lithium-ion battery.

In a third aspect, the invention provides use of a mixed niobium oxide is as defined in the first aspect as an active electrode material in a metal-ion battery. Optionally the metal-ion battery is a lithium-ion battery or a sodium-ion battery, preferably a lithium-ion battery.

In a fourth aspect, the invention provides a method of making an electrode, comprising providing a mixed niobium oxide as defined in the first aspect; and depositing the mixed niobium oxide onto a current collector, thereby forming the electrode.

### SUMMARY OF THE FIGURES

The principles of the invention will now be discussed with reference to the accompanying figures.

FIG. 1: XRD patterns of selected synthesised Wadsley-Roth 4×4 octahedral block structures.

FIG. 2: TEM micrographs and selected area electron diffraction acquired using a Thermo Scientific (FEI) Talos F200X G2 TEM of Sample 11. Left: High magnification imaging showing highly crystalline structure. Right: Selected area electron diffraction with the (110) interplanar distance matching that determined by XRD.

FIG. 3: XRD pattern for sample 18 collected using a CuKα X-ray source.

FIG. 4: Voltage vs. state of charge/discharge curves of the 2^{nd} cycle formation for samples 3 and 18 within half-cells using a C-rate of C/10 from 3.0 to 1.1 V.

### DETAILED DESCRIPTION OF THE INVENTION

The term “mixed niobium oxide” refers to an oxide comprising niobium and at least one other cation. mixed niobium oxides have a high redox voltage vs. Lithium>0.8V, enabling safe and long lifetime operation, crucial for fast charging battery cells. Moreover, niobium cations can have two redox reactions per atom, resulting in higher theoretical capacities than, for example, LTO.

The mixed niobium oxide may have the formula M^{I}ₓ₋ᵤM^{y}_{(x(5-y))} M^{V}_{z}Nb_{100-(x/(5-y))-z}O_{250-u/2}, wherein:
M^{I} is a cation having an oxidation state of 1;
M^{y} is a cation having an average oxidation state of y;
M^{V} is a cation having an average oxidation state of 5;

$$\begin{matrix}1 \leq y \leq 4 ; \\ 0.5 \leq x \leq 6 ; \\ 0 \leq z \leq 10 ; \\ 0 \leq u \leq 5 ; \\ x > u .\end{matrix}$$

The mixed niobium oxide may also have the formula BₐM^{v}_{z}Nb_{100-a-z}O₂₅₀₋ₐ, wherein
M^{V} is a cation having an average oxidation state of 5;

$$\begin{matrix}0 \leq z \leq 10 ; \\ 0 < a \leq 8 .\end{matrix}$$

The mixed niobium oxide may also have the formula M_{b}Nb_{100-b}O_{250-2.5b+bc}, wherein
M is a cation selected from P, B, W, Mo, V, Ti, Si, and mixtures thereof;
c is half of the average oxidation state of M;

$$1.5 \leq c \leq 3 ; and$$

$$0.5 < b \leq 6 .$$

The mixed niobium oxides having the formulas defined herein are unified because they may adopt a crystal structure which is believed to contribute towards their advantageous properties for use as active electrode materials. In particular, the mixed niobium oxides may adopt a crystal structure having a Wadsley-Roth crystal structure comprising 4×4 octahedral blocks. Wadsley-Roth crystal structures are considered to be a crystallographic off-stoichiometry of the MO₃ (ReO₃) crystal structure containing crystallographic shear, with simplified formula of MO₃₋ₓ. As a result, these structures typically contain [MO₆] octahedral subunits in their crystal structure. In the 4×4 octahedral block structure each block is connected through edge-sharing octahedra only. This structure was reported in 1967 as having a monoclinic unit cell (a=28.51 Å, b=3.830 Å, c=17.48 Å, β=120.80°, space group=C2/m). This and related structures have been reported in historic academic literature but no electrochemical lithiation or de-lithiation data has been provided (Andersson, Zeitschrift für anorganische und allgemeine Chemie, Volume 351, Issue 1-2, April 1967, Pages 106-112; Pekhtereva, Yu. A., & Shukaev, I. L. (1999), Zhurnal Neorganicheskoj Khimii, 44 (2), 290-294; Cava et al 1983 J. Electrochem. Soc. 130 2345; Villafuerte-Castrejón, Journal of Solid State Chemistry, Volume 71, Issue 1, November 1987, Pages 103-108; Norin and Bertil, Acta Chemica Scandinavica, volume 25 (1971), Pages: 741-743; Reisman and Holtzberg, J. Am. Chem. Soc. 1958, 80, 24, 6503-6507). It is believed that the large block size is advantageous for rapid insertion and removal of lithium as compared to other Wadsley-Roth structures of smaller octahedral block sizes, with potentially higher stability than those with larger octahedral block sizes.

The polymorph of niobium oxide N—Nb₂O₅ adopts a Wadsley-Roth crystal structure comprising 4×4 octahedral blocks. Accordingly, the crystal structure of the mixed niobium oxide, as determined by X-ray diffraction, preferably corresponds to the crystal structure of N—Nb₂O₅. The crystal structure of N—Nb₂O₅ may be found at Andersson 1967, Zeitschrift für anorganische und allgemeine Chemie, Volume 351, Issue 1-2, April 1967.

Compared to the empirical formula of N—Nb₂O₅, the mixed niobium oxides according to the invention have a modified ratio of cations to anions. In the formula M^{I}ₓ₋ᵤM^{y}_{(x(5-y))}M^{V}_{z}Nb_{100-(x/(5-y))-z}O_{250-u/2} some Nb has been substituted by both M^{I} and M^{y}, increasing the ratio of cations to anions. In the formula BₐM^{v}_{z}Nb_{100-a-z}O₂₅₀₋ₐ some Nb has been substituted by B causing the loss of oxygen from the crystal structure to maintain charge neutrality, also increasing the ratio of cations to anions; the crystal structure of materials having this formula may contain some tetrahedral boron cations between the 4×4 octahedral blocks. This modification is believed to contribute towards the advantageous properties of the mixed niobium oxides for use as active electrode materials. For instance, the modified cation to anion ratio is believed to stabilise the crystal structure.

The crystal structure of a material may be determined by analysis of X-ray diffraction (XRD) patterns, typically obtained from a Cu Kα source, as is widely known. For instance, XRD patterns obtained from a given material can be compared to known XRD patterns to confirm the crystal structure, e.g. via public databases such as the ICDD crystallography database. Rietveld analysis and Pawley analysis can also be used to determine the crystal structure of materials, in particular for the unit cell parameters. Therefore, the mixed niobium oxide may have a Wadsley-Roth crystal structure comprising 4×4 octahedral blocks, as determined by X-ray diffraction.

Here the term ‘corresponds’ is intended to reflect that peaks in an X-ray diffraction pattern may be shifted by no more than 0.5 degrees (preferably shifted by no more than 0.25 degrees, more preferably shifted by no more than 0.1 degrees) from corresponding peaks in an X-ray diffraction pattern of the material listed above.

The mixed niobium oxide may adopt a monoclinic crystal structure, for example having unit cell parameters a=25.7-31.4 Å, b=3.4-4.2 Å, c=15.8-19.3 Å, α=90°, β=112.6-137.6°, γ=90°. Unit cell parameters may be determined by X-ray diffraction.

M^{I} is a cation having an oxidation state of 1. M^{I} may be selected from Li, Na, K, and mixtures thereof. Preferably, M^{I} is selected from Li, Na, and mixtures thereof.

x is the atomic amount of M^{I}, having the range 0.5≤x≤6. x may be an integer, e.g. x=1, 2, 3, 4, 5, or 6. Optionally, 2≤x≤5, such as x=2, 3, 4, or 5. Preferably, x=4.

The formula may be deficient in M^{I}, e.g. if some of the 1+ cation is lost via volatility since it typically has a low atomic weight. Accordingly, the atomic amount of x may be modified by variable 0≤u≤5, where x>u, e.g. x≥u+1. Optionally 0≤u≤3 or 0.01≤u≤2. Alternatively, u=0.

M^{y} is a cation having an average oxidation state of y. The term “average oxidation state” means that when more than one cation is present the oxidation state refers to M^{y} as a whole. For example, if ⅓ of M^{y} is W⁶⁺ and ⅔ of M^{y} is Fe³⁺, then y is 4 (⅓×6 (the contribution from W)+⅔×3 (the contribution from Fe)). However, M^{y}, M^{II}, M^{III}, M^{IV}, and M^{V} may consist of a single cation, in which case the oxidation state is the oxidation state of that cation.

M^{y} may be selected from Li, Na, K, Cu, Zn, Mg, Ca, Ni, Fe, Mn, Co, Cr, V, Al, B, Ga, Sc, Y, In, La, Yb, Ce, Zr, Ti, Sn, Ge, Si, P, Ta, W, Mo, and mixtures thereof; or Li, Na, K, Cu, Zn, Mg, Ni, Fe, Mn, Co, Cr, V, Al, B, Ga, Zr, Ti, Si, P, Ta, and mixtures thereof; or Li, Na, Cu, Zn, Mg, Ni, Fe, Mn, Co, Cr, Al, B, Ga, Zr, Ti, and mixtures thereof. Optionally, M^{y} does not contain Li.

y has the range 1≤y≤4, optionally 2≤y≤4. y may be an integer, e.g. y=1, 2, 3, or 4; preferably 2, 3, and 4. When y is an integer, optionally all cations forming M^{y} have the same oxidation state.

When y is 1, 2, 3, or 4 M^{y} may be selected from Li, Na, Cu, Zn, Mg, Ca, Ni, Fe, Mn, Co, Cr, Al, B, Ga, Sc, Y, In, La, Yb, Ce, Zr, Ti, Sn, Ge, and mixtures thereof.

When y is 2, 3, or 4 M^{y} may be selected from Cu, Zn, Mg, Ca, Ni, Fe, Mn, Co, Mn, Cr, Al, B, Ga, Sc, Y, In, La, Yb, Ce, Zr, Ti, Sn, Ge, and mixtures thereof.

The atomic amount of M^{y} depends on the amount of M^{I} and the oxidation state of M^{y}, having the relationship x/(5−y).

M^{V} is an optional cation having an average oxidation state of 5. Optionally, M^{V} is a cation having an oxidation state of 5, wherein all cations forming M^{V} have the same oxidation state of 5.

The atomic amount of M^{V} is z, having the range 0≤z≤10. Optionally, 0≤z≤5. z may be >0, e.g. >0.01. Alternatively, z=0 in which case M^{V} is not present.

M^{V} may be selected from Mn, Fe, Al, Ga, Y, In, La, Yb, Cu, Zn, Mg, Ni, Co, Ca, Ce, Zr, Ti, Sn, Ge, Si, V, P, Ta, W, Mo, Cr, and mixtures thereof; or Ce, Zr, Ti, Sn, Ge, Si, V, P, Ta, W, Mo, CrV, P, Ta, and mixtures thereof; or V, P, Ta, and mixtures thereof. Optionally all cations forming M^{V} have an oxidation state of 5.

When y=1, the mixed niobium oxide may have the formula M^{I}ₓ₋ᵤN^{I}_{x/4}M^{V}_{z}Nb_{100-x/4-z}O_{250-u/2}, wherein N^{I} is a cation having an oxidation state of 1. N^{I} may be selected from Li, Na, K and mixtures thereof; preferably Li, Na, and mixtures thereof.

When y=2, the mixed niobium oxide may have the formula M^{I}ₓ₋ᵤM^{II}_{x/3}M^{V}_{z}Nb_{100-x/3-z}O_{250-u/2}, wherein M^{II} is a cation having an average oxidation state of 2. M^{II} may be selected from Cu, Zn, Mg, Ni, Fe, Mn, Co, Ca, and mixtures thereof; or Cu, Zn, Mg, Ni, and mixtures thereof; or Zn, Mg, Ni, and mixtures thereof. Optionally all cations forming M^{II} have an oxidation state of 2.

When y=3, the mixed niobium oxide may have the formula M^{I}ₓ₋ᵤM^{III}_{x/2}M^{V}_{z}Nb_{100-x/2-z}O_{250-u/2}, wherein M^{III} is a cation having an average oxidation state of 3. M^{III} may be selected from Mn, Cr, V, Fe, Al, B, Ga, Y, In, La, Yb, Ce, and mixtures thereof; or Mn, Cr, Fe, Al, B, Ga, Y, and mixtures thereof; or Cr, Al, Fe, and mixtures thereof. Optionally all cations forming M^{III} have an oxidation state of 3.

When y=4, the mixed niobium oxide may have the formula M^{I}ₓ₋ᵤM^{IV}ₓM^{V}₂Nb_{100-x-z}O_{250-u/2}, wherein M^{IV} is a cation having an average oxidation state of 4. M^{IV} may be selected from Zr, Ti, Mn, Ce, Sn, Ge, V, Si, and mixtures thereof; or Zr, Ti, Sn, Ge, V, and mixtures thereof; or Ti, V, and mixtures thereof. Optionally all cations forming M^{IV} have an oxidation state of 4.

The atomic amount of B in BₐM^{v}₂Nb_{100-a-z}O₂₅₀₋ₐ is a, having the range 0<a≤8, for example 0.01<a≤8. Optionally, 1≤a≤5 or 1.5≤a≤3. a may be an integer. Preferably a=2. Up to 10 at. % of the cations may be partially substituted by at least one cation selected from P, K, Fe, Ti, Zr, Sn, Ge, Zn, Mg, Al, Ga, Y, W, Mo, Cr, V, Si, Ni, Mn, Ta, Li, Na, and mixtures thereof; or Ti, W, Mo, Cr, Zn, Al, Fe, P, and mixtures thereof.

In M_{b}Nb_{100-b}O_{250-2.5b+bc} as described above, M is a cation selected from P, B, W, Mo, V, Ti, Si, and mixtures thereof. M may be selected from P, W, B, Ti, and mixtures thereof; or P, W, and mixtures thereof. Preferably M comprises P and/or W. Up to 10 at. % of the cations may be partially substituted by at least one cation selected from K, Fe, Zr, Sn, Ge, Zn, Mg, Al, Ga, Y, Cr, Ni, Mn, Ta, Li, Na and mixtures thereof; or Cr, Zn, Al, Fe, and mixtures thereof. b is 0.5<b≤6, or 1≤b≤5.75, or 1.5≤b≤5.5. c is half of the average oxidation state of M and is 1.5≤c≤3, or 2≤c≤2.75, or 2.5.

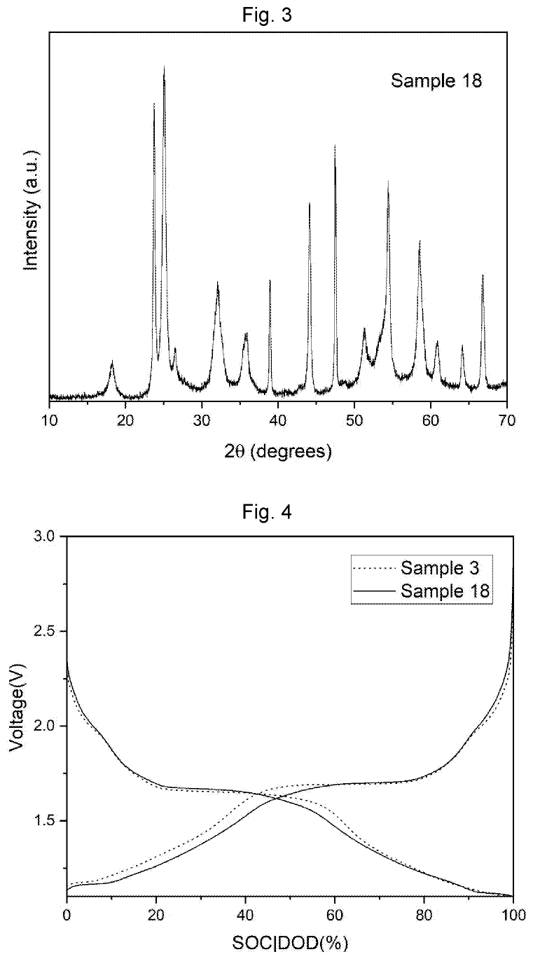

In an X-ray diffraction pattern of M_{b}Nb_{100-b}O_{250-2.5b+bc} from a CuKα source, the most intense peak between 18.15-18.65° 2θ may have a full width half maximum of >0.2; optionally >0.4, >0.6, and/or <0.9 (e.g. >0.2 to <0.9). FIG. 3 shows an XRD pattern of a sample having this peak. It is believed that samples with this peak encompass the presence of some connecting tetrahedral cations between the 4×4 octahedral blocks within the Wadsley-Roth crystal structure. Materials having this crystal structure were found to have particularly high capacity.

It will be understood that the discussion of the variables of the formula (e.g. M, M^{I}, x, u, M^{y}, y, M^{v}, z, a, b, c) is intended to be read in combination. For example, the mixed niobium oxide may have the formula

M^{I}ₓ₋ᵤM^{y}_{(x/(5-y))}M^{V}_{z}Nb_{100-(x/(5-y))-z}O_{250-u/2}, wherein:
M^{I} is Li, Na, and mixtures thereof;
M^{y} is a cation having an average oxidation state of y selected from Li, Na, Cu, Zn, Mg, Ca, Ni, Fe, Mn, Co, Cr, Al, B, Ga, Sc, Y, In, La, Yb, Ce, Zr, Ti, Sn, Ge, and mixtures thereof;
M^{V} is a cation having an average oxidation state of 5 selected from V, P, Ta, and mixtures thereof;

$$\begin{matrix}1 \leq y \leq 4 ; \\ 2 \leq x \leq 6 ; \\ 0 \leq z \leq 10 ; \\ 0 \leq u \leq 3 ; \\ x \geq u + 1.\end{matrix}$$

For example, the mixed niobium oxide may have the formula M^{I}ₓM^{y}_{(x(5-y))}Nb_{100-(x/(5-y))} O₂₅₀, wherein:
M^{I} is Li, Na, and mixtures thereof;
M^{y} is a cation having an oxidation state of y selected from Li, Na, Cu, Zn, Mg, Ca, Ni, Fe, Mn, Co, Cr, Al, B, Ga, Sc, Y, In, La, Yb, Ce, Zr, Ti, Sn, Ge, and mixtures thereof, wherein all cations forming M^{y} have the same oxidation state;
y=1, 2, 3, or 4;
x=3, 4, or 5.

M^{y}, M^{I}, N^{I}, M^{II}, M^{III}, M^{IV}, and M may also be selected from each of the specific elements used as such in the examples.

Optionally, the mixed niobium oxide only contains Li if a further cation other than Li and Nb is present. An example of such a material is Li₄Cr₂Nb₉₈O₂₅₀, where Cr is the cation other than Li and Nb. In addition, the mixed niobium oxide may be free from Li. It will be understood that the mixed niobium oxides, including those free from Li, may reversibly intercalate Li in situ when acting as an active electrode material in a lithium-ion battery.

The cations in the mixed niobium oxide may be partially substituted by further cations of different oxidation state, for example up to 20 at. %, 10 at. %, or 5 at. % of cations may be substituted. Substitution by a cation of different oxidation state forms a charge imbalanced material. The charge imbalance may be compensated for by oxygen deficiency (for substitution by a cation of lower oxidation state) or excess (for substitution by a cation of higher oxidation state). Alternately or in addition, the charge imbalance may be compensated for by oxidation or reduction of cations.

The oxygen anions may be partially substituted by an alternative electronegative anion such as F, Cl, Br, S, Se, N, and mixtures thereof. Optionally up to 10 at. % or 5 at % of the oxygen anions may be partially substituted by an alternative electronegative anion.

The mixed niobium oxide is preferably in particulate form. The mixed niobium oxide may have a D₅₀ particle diameter in the range of 0.1-100 μm, or 0.5-50 μm, or 1-20 μm. These particle sizes are advantageous because they are easy to process and fabricate into electrodes. Moreover, these particle sizes avoid the need to use complex and/or expensive methods for providing nanosized particles. Nanosized particles (e.g. particles having a D₅₀ particle diameter of 100 nm or less) are typically more complex to synthesise and require additional safety considerations.

The mixed niobium oxide may have a D₁₀ particle diameter of at least 0.05 μm, or at least 0.1 μm, or at least 0.5 μm, or at least 1 μm. By maintaining a D₁₀ particle diameter within these ranges, the potential for parasitic reactions in a Li ion cell is reduced from having reduced surface area, and it is easier to process with less binder in the electrode slurry.

The mixed niobium oxide may have a Doo particle diameter of no more than 200 μm, no more than 100 μm, no more than 50 μm, or no more than 20 μm. By maintaining a D₉₀ particle diameter within these ranges, the proportion of the particle size distribution with large particle sizes is minimised, making the material easier to manufacture into a homogenous electrode.

The term “particle diameter” refers to the equivalent spherical diameter (esd), i.e. the diameter of a sphere having the same volume as a given particle, where the particle volume is understood to include the volume of any intra-particle pores. The terms “Dₙ” and “Dₙ particle diameter” refer to the diameter below which n % by volume of the particle population is found, i.e. the terms “D₅₀” and “D₅₀ particle diameter” refer to the volume-based median particle diameter below which 50% by volume of the particle population is found. Where a material comprises primary crystallites agglomerated into secondary particles, it will be understood that the particle diameter refers to the diameter of the secondary particles. Particle diameters can be determined by laser diffraction. Particle diameters can be determined in accordance with ISO 13320:2009, for example using Mie theory.

The mixed niobium oxide may have a BET surface area in the range of 0.1-100 m²/g, or 0.2-50 m²/g, or 0.5-20 m²/g. In general, a low BET surface area is preferred in order to minimise the reaction of the mixed niobium oxide with the electrolyte, e.g. minimising the formation of solid electrolyte interphase (SEI) layers during the first charge-discharge cycle of an electrode comprising the material. However, a BET surface area which is too low results in unacceptably low charging rate and capacity due to the inaccessibility of the bulk of the mixed niobium oxide to metal ions in the surrounding electrolyte.

The term “BET surface area” refers to the surface area per unit mass calculated from a measurement of the physical adsorption of gas molecules on a solid surface, using the Brunauer-Emmett-Teller theory. For example, BET surface areas can be determined in accordance with ISO 9277:2010.

The mixed niobium oxide may be coated with carbon, e.g. to improve its surface electronic conductivity and/or to prevent reactions with electrolyte.

The mixed niobium oxide may have a protective coating; optionally the protective coating comprises niobium oxide, aluminium oxide, zirconium oxide, organic or inorganic fluorides, organic or inorganic phosphates, titanium oxide, lithiated versions thereof, and mixtures thereof.

In the first aspect the mixed niobium oxide forms the active electrode material of an electrode, preferably of an anode for a lithium-ion battery. However, any of the mixed niobium oxides defined herein may be provided as an active electrode material suitable for incorporating into an electrode. For example, the mixed niobium oxides disclosed herein may be provided as raw materials, not as part of an electrode, e.g. for sale to electrode manufacturers.

The electrode is typically of the form of an electrode composition in electrical contact with a current collector, where the electrode composition comprises the mixed niobium oxide. A current collector is typically a metal foil, e.g. copper or aluminium foil.

Optionally, the mixed niobium oxide forms at least 5 wt. %, 10 wt. %, or 50 wt. % of the total active electrode material in the electrode. The mixed niobium oxide may form the sole active electrode material in the electrode.

The electrode composition may further comprise at least one other component selected from a binder, a conductive additive, a different active electrode material (e.g. a further mixed niobium oxide as defined herein), and mixtures thereof. For instance, one electrode composition comprises about 92 wt % mixed niobium oxide, about 5 wt % conductive additive (e.g. carbon black), and about 3 wt % binder (e.g. poly(vinyldifluoride)), based on the total dry weight of the electrode composition.

Examples of suitable binders include polyvinylidene fluoride and its copolymers (PVDF), polytetrafluoroethylene (PTFE) and its copolymers, polyacrylonitrile (PAN), poly(methyl) methacrylate or poly(butyl) methacrylate, polyvinyl chloride (PVC), polyvinyl fomal, polyetheramide, polymethacrylic acid, polyacrylamide, polyitaconic acid, polystyrene sulfonic acid, polyacrylic acid (PAA) and alkali metal salts thereof, modified polyacrylic acid (mPAA) and alkali metal salts thereof, cellulose-based polymers, carboxymethylcellulose (CMC), modified carboxymethylcellulose (mCMC), sodium carboxymethylcellulose (Na-CMC), polyvinylalcohol (PVA), alginates and alkali metal salts thereof, butadieneacrylonitrile rubber (NBR), hydrogenated form of NBR (HNBR), styrene-butadiene rubber (SBR) and polyimide. The binder may be present in the electrode composition at 0-30 wt %, or 0.1-10 wt %, or 0.1-5 wt %, based on the total dry weight of the electrode composition.

Conductive additives are preferably non-active materials which are included so as to improve electrical conductivity between the active electrode material and between the active electrode material and the current collector. The conductive additives may suitably be selected from graphite, carbon black, carbon fibers, vapor-grown carbon fibres (VGCF), carbon nanotubes, graphene, acetylene black, ketjen black, metal fibers, metal powders and conductive metal oxides. Preferred conductive additives include carbon black and carbon nanotubes. Conductive additives may be present in the electrode composition at 0-20 wt %, 0.1-10 wt %, or 0.1-5 wt %, based on the total dry weight of the electrode composition.

The active electrode material may be present in the electrode composition at 100-50 wt %, 99.8-80 wt %, or 99.8-90 wt %, based on the total dry weight of the electrode composition. When the active electrode material is present at 100 wt. % of the electrode composition it may for a solid-state electrode.

When a different active electrode material is present in addition to the mixed niobium oxide, it may be selected from lithium titanium oxide, titanium niobium oxide, a different mixed niobium oxide, graphite, hard carbon, soft carbon, silicon, doped versions thereof, and mixtures thereof.

The mixed niobium oxide may be in combination with a lithium titanium oxide to form an active electrode material.

The lithium titanium oxide preferably has a spinel or ramsdellite crystal structure, e.g. as determined by X-ray diffraction. An example of a lithium titanium oxide having a spinel crystal structure is Li₄Ti₅O₁₂. An example of a lithium titanium oxide having a ramsdellite crystal structure is Li₂Ti₃O₇. These materials have been shown to have good properties for use as active electrode materials. Therefore, the lithium titanium oxide may have a crystal structure as determined by X-ray diffraction corresponding to Li₄Ti₅O₁₂ and/or Li₂Ti₅O₇. The lithium titanium oxide may be selected from Li₄Ti₅O₁₂, Li₂Ti₃O₇, and mixtures thereof. The lithium titanium oxide may be doped with additional cations or anions. The lithium titanium oxide may be oxygen deficient. The lithium titanium oxide may comprise a coating, optionally wherein the coating is selected from carbon, polymers, metals, metal oxides, metalloids, phosphates, and fluorides.

The lithium titanium oxide may be synthesised by conventional ceramic techniques, for example solid-state synthesis or sol-gel synthesis. Alternatively, the lithium titanium oxide may be obtained from a commercial supplier.

The lithium titanium oxide is in preferably in particulate form. The lithium titanium oxide may have a D₅₀ particle diameter in the range of 0.1-50 μm, or 0.25-20 μm, or 0.5-15 μm. The lithium titanium oxide may have a D₁₀ particle diameter of at least 0.01 μm, or at least 0.1 μm, or at least 0.5 μm. The lithium titanium oxide may have a Doo particle diameter of no more than 100 μm, no more than 50 μm, or no more than 25 μm. By maintaining a D₉₀ particle diameter in this range the packing of lithium titanium oxide particles in the mixture with mixed niobium oxide particles is improved.

Lithium titanium oxides are typically used in battery anodes at small particle sizes due to the low electronic conductivity of the material. In contrast, the mixed niobium oxide as defined herein may be used at larger particle sizes since it typically has a higher lithium ion diffusion coefficient than lithium titanium oxide. Advantageously, in the composition the lithium titanium oxide may have a smaller particle size than the mixed niobium oxide, for example such that the ratio of the D₅₀ particle diameter of the lithium titanium oxide to the D₅₀ particle diameter of the mixed niobium oxide is in the range of 0.01:1 to 0.9:1, or 0.1:1 to 0.7:1. In this way, the smaller lithium titanium oxide particles may be accommodated in the voids between the larger mixed niobium oxide particles, increasing the packing efficiency of the composition.

The lithium titanium oxide may have a BET surface area in the range of 0.1-100 m²/g, or 1-50 m²/g, or 3-30 m²/g.

The ratio by mass of the lithium titanium oxide to the mixed niobium oxide may be in the range of 0.5:99.5 to 99.5:0.5, preferably in the range of 2:98 to 98:2. In one implementation the active electrode material comprises a higher proportion of the lithium titanium oxide than the mixed niobium oxide, e.g. the ratio by mass of at least 2:1, at least 5:1, or at least 8:1. Advantageously, this allows the mixed niobium oxide to be incrementally introduced into existing electrodes based on lithium titanium oxides without requiring a large change in manufacturing techniques, providing an efficient way of improving the properties of existing electrodes. In another implementation the active electrode material has a higher proportion of the mixed niobium oxide than the lithium titanium oxide, e.g. such that the ratio by mass of the lithium titanium oxide to the mixed niobium oxide is less than 1:2, or less than 1:5, or less than 1:8. Advantageously, this allows for the cost of the active electrode material to be reduced by replacing some of the mixed niobium oxide with lithium titanium oxide.

The mixed niobium oxide may be in combination with a niobium oxide to form an active electrode material. The niobium oxide may be selected from Nb₁₂O₂₉, NbO₂, NbO, and Nb₂O₅. Preferably, the niobium oxide is Nb₂O₅.

The niobium oxide may be doped with additional cations or anions, for example provided that the crystal structure of the niobium oxide corresponds to the crystal structure of an oxide consisting of Nb and O, e.g. Nb₁₂O₂₉, NbO₂, NbO, and Nb₂O₅. The niobium oxide may be oxygen deficient. The niobium oxide may comprise a coating, optionally wherein the coating is selected from carbon, polymers, metals, metal oxides, metalloids, phosphates, and fluorides.

The niobium oxide may have the crystal structure of Nb₁₂O₂₉, NbO₂, NbO, or Nb₂O₅ as determined by X-ray diffraction. For example, the niobium oxide may have the crystal structure of orthorhombic Nb₂O₅ or the crystal structure of monoclinic Nb₂O₅. Preferably, the niobium oxide has the crystal structure of monoclinic Nb₂O₅, most preferably the crystal structure of H—Nb₂O₅. Further information on crystal structures of Nb₂O₅ may be found at Griffith et al., J. Am. Chem. Soc. 2016, 138, 28, 8888-8899. The niobium oxide may be synthesised by conventional ceramic techniques, for example solid-state synthesis or sol-gel synthesis. Alternatively, the niobium oxide may be obtained from a commercial supplier.

The niobium oxide is in preferably in particulate form. The niobium oxide may have a D₅₀ particle diameter in the range of 0.1-100 μm, or 0.5-50 μm, or 1-20 μm. The niobium oxide may have a D₁₀ particle diameter of at least 0.05 μm, or at least 0.5 μm, or at least 1 μm. The niobium oxide may have a D₉₀ particle diameter of no more than 100 μm, no more than 50 μm, or no more than 25 μm. By maintaining a D₉₀ particle diameter in this range the packing of niobium oxide particles in the mixture with mixed niobium oxide particles is improved.

The niobium oxide may have a BET surface area in the range of 0.1-100 m²/g, or 1-50 m²/g, or 1-20 m²/g.

The ratio by mass of the niobium oxide to the mixed niobium oxide may be in the range of 0.5:99.5 to 99.5:0.5, or in the range of 2:98 to 98:2, or preferably in the range of 15:85 to 35:55.

The invention also provides the use of the mixed niobium oxides defined herein in an anode for a metal-ion battery, optionally wherein the metal-ion battery is a lithium-ion or sodium-ion battery, preferably a lithium-ion battery. Lithium-ion batteries include liquid-based batteries, polymer-based batteries, semi-solid-based batteries and full solid-state-based batteries.

A further implementation of the invention is an electrochemical device comprising an anode, a cathode, and an electrolyte disposed between the anode and the cathode, wherein the anode comprises an active electrode material according to the first aspect of the invention; optionally wherein the electrochemical device is metal-ion battery such as a lithium-ion battery or a sodium-ion battery. For example, the anode may be an electrode in accordance with the first aspect of the invention. Preferably, the electrochemical device is a lithium-ion battery having a reversible anode active material specific capacity of greater than 180 mAh/g at 20 mA/g, wherein the battery can be charged and discharged at current densities relative to the anode active material of 200 mA/g or more, or 1000 mA/g or more, or 2000 mA/g or more, or 4000 mA/g or more whilst retaining greater than 70% of the initial cell capacity at 20 mA/g. It has been found that use of the active electrode materials of the first aspect of the invention can enable the production of a lithium-ion battery with this combination of properties, representing a lithium-ion battery that is particularly suitable for use in applications where high charge and discharge current densities are desired. Notably, the examples have shown that active electrode materials according to the first aspect of the invention have excellent capacity retention at high C-rates.

The electrochemical device preferably has an N/P ratio>1, wherein N/P is defined as:

$$\frac{\begin{matrix}areal loading ( mg {cm}^{- 2} ) ( anode ) \times active fraction ( wt \% ) ( anode ) \times \\ first lithiation capacity ( {mAhg}^{- 1} ) ( anode )\end{matrix}}{areal loading ( mg {cm}^{- 2} ) ( cathode ) \times active fraction ( wt \% ) ( cathode ) \times first delithiation capacity ( {mAhg}^{- 1} ) ( cathode )}$$

wherein:
areal loading (mgcm⁻²) is the dry loading of the electrode composition, not taking into account the current collector;
active fraction (wt %) is the percentage of the dry electrode composition that is active material;
first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode.

The first lithiation/delithiation capacity is measured on an equivalent half-cell. An equivalent half-cell can be understood to utilise the same electrode composition deposited at the same areal loading and active fraction as the full cell. For the anode, the first constant current C/10 lithiation (discharge, negative current) capacity (vs Li/Li+) at 25° C. is measured. For the cathode, the first constant current C/10 delithiation (charge, positive current) capacity (vs Li/Li+) at 25° C. is measured.

N/P is preferably greater than one, e.g. ≥1.01. N/P may be in the range of >1-2, or 1.01-1.5, or most preferably 1.05-1.3.

The cathode comprises an active cathode material which may be selected from nickel-based layered oxides of the class LiNi₁₋ₓMₓO₂ where M=Co, Mn, Al such as NMCs—lithium nickel manganese cobalt oxides, NCAs—lithium cobalt aluminium oxides, and LCOs—lithium cobalt oxides; and LNMOs—lithium nickel manganese oxides (e.g. LiNi_{0.5}Mn_{1.5}O₄). For example, the active cathode material may be a lithium nickel manganese cobalt oxide. Active cathode materials are widely available from commercial suppliers. Active cathode materials may be doped with additional cations and/or anions.

The choice of the active electrode material can affect the appropriate voltage range, including for determining the first lithiation/delithiation capacity. For example, appropriate voltage ranges may be LNMO: 5.2-3V, upper cut off 5.2V; NCA, NMC, and LCO: 4.5-2.7V, upper cut off 4.5V; mixed niobium oxide: 3-0V, lower cut off 0V. Narrower ranges may be LNMO: 5-3V, upper cut off 5V; NCA, NMC, and LCO: 4.3-2.7V, upper cut off 4.3V; mixed niobium oxide: 3V-1.0V, lower cut off 1.0V.

An appropriate voltage range may be determined empirically. For example, the voltage profile correlates to the change in energy state of the anode and cathode materials associated with removal or insertion of electrons and ions. The cut-off voltage for the cell may be selected to fall before a specific inflection point in the voltage profile which corresponds to a rise in energy state of one or both electrodes beyond a critical level which leads the crystal structure to decay to a lower energy structure at a rate which is significantly harmful to the cell's performance. The absolute voltage at which this happens is a function of the electrode potentials of both electrodes, but can be calculated by use of a common reference electrode and need not be determined experimentally for well-established material families with reliable standard electrochemical behaviour.

The cathode active material is preferably in particulate form, e.g. having a D50 particle diameter in the range of 0.1-100 μm, or 0.5-50 μm, or 1-20 μm.

The electrolyte may include any material suitable for metal-ion battery operation, preferably lithium-ion battery operation. For example, the electrolyte may be a non-aqueous solution (e.g., an organic electrolytic solution). The electrolyte may include one or more non-aqueous solvents and a salt that is at least partially dissolved in the solvent. For example, the solvent may include an organic solvent, such as, e.g., ethylene carbonate (EC) and/or other carbonate based solvents, or butyrate, or acetate, or mixtures thereof. The solvent may include 1 M LiPF₆ dissolved in an aprotic solvent mixture, such as a 1:1 by weight of a mixture of ethylene carbonate and other carbonate based solvents or butyrate or acetate. Salts suitable for use in the invention include LiPF₆, LiSbF₆, LiBF₄, LiTFSI, LIFSI, LiAlCl₄, LiASF₆, LiClO₄, LiGaCl₄, LiC(SO₂CF₃)₃, LiN(CF₃SO₂)₂, Li(CF₃SO₃), LiB(C₆H₄O₂)₂, LiBOB (lithium bis(oxalate) borate), and LiDFOB (lithium difluoro (oxalate) borate). Low-viscosity solvents (e.g., organic solvents) suitable for use in the electrolyte may include, but are not limited to ethyl methyl carbonate (EMC), dioxlane (DOL), ethyl acetate (EA); propylene acetate (PA); butyl acetate (BA); methyl butyrate (MB); ethyl butyrate (EB); dimethyl carbonate (DMC); diethyl carbonate (DEC); 1,2-dimethoxyethane (DME); tetrahydrofuran (THF); methyl acetate (MA); diglyme (DGL); triglyme; tetraglyme; cyclic carbonates; cyclic esters; cyclic amides; propylene carbonate (PC); methyl propyl carbonate (MPC); acetonitrile; dimethyl sulfoxide (DMS); dimethyl formamide; dimethyl acetamide; gamma-butyrolactone (GBL); and N-methyl-pyrrolidinone (NMP); as well as various mixtures or combinations thereof.

The mixed niobium oxide may be synthesised by conventional ceramic techniques. For example, it may be made by one or more of solid-state synthesis or sol-gel synthesis. The mixed niobium oxide may additionally be synthesised by one or more of alternative techniques commonly used, such as hydrothermal or microwave hydrothermal synthesis, solvothermal or microwave solvothermal synthesis, coprecipitation synthesis, spark or microwave plasma synthesis, combustion synthesis, electrospinning, spray pyrolysis, chemical vapour deposition, atomic layer deposition, and mechanical alloying.

The mixed niobium oxide may be provided by a method comprising steps of: providing one or more precursor materials; mixing said precursor materials to form a precursor material mixture; and heat treating the precursor material mixture in a temperature range from 400° C.-1350° C. or 800-1250° C., thereby providing the mixed niobium oxide.

To provide a mixed niobium oxide comprising an additional electronegative anion than oxygen the method may further comprise the steps of: mixing the mixed niobium oxide with a precursor comprising an additional electronegative anion to provide a further precursor material mixture; and heat treating the further precursor material mixture in a temperature range from 300-1200° C. or 800-1100° C. optionally under reducing conditions, thereby providing the mixed niobium oxide comprising an additional electronegative anion.

For example, to provide a mixed niobium oxide comprising N, the method may further comprise the steps of: mixing the mixed niobium oxide with a precursor comprising N (for example melamine or urea) to provide a further precursor material mixture; and heat treating the further precursor material mixture in a temperature range from 300-1200° C. under reducing conditions (for example under N₂), thereby providing the mixed niobium oxide comprising N.

For example, to provide a mixed niobium oxide comprising F, the method may further comprise the steps of: mixing the mixed niobium oxide with a precursor comprising F (for example polyvinylidene fluoride or NH₄F) to provide a further precursor material mixture; and heat treating the further precursor material mixture in a temperature range from 300-1200° C. under oxidising conditions (for example in air), thereby providing the mixed niobium oxide comprising F.

The method may comprise the further step of heat treating the mixed niobium oxide in a temperature range from 400-1350° C. or 800-1250° C. under reducing conditions, thereby inducing oxygen vacancies in the mixed niobium oxide.

The precursor materials for making the mixed niobium oxide may include one or more metal oxides, metal hydroxides, metal salts or ammonium salts. For example, the precursor materials may include one or more metal oxides or metal salts of different oxidation states and/or of different crystal structure. Examples of suitable precursor materials include but are not limited to: Nb₂O₅, Nb(OH)₅, Niobic Acid, NbO, Ammonium Niobate Oxalate, NH₄H₂PO₄, (NH₄)₂PO₄, (NH₄)₃PO₄, P₂O₅, H₃PO₃, Ta₂O₅, WO₃, ZrO₂, TiO₂, MoO₃, V₂O₅, ZrO₂, CuO, ZnO, Al₂O₃, K₂O, KOH, CaO, GeO₂, Ga₂O₃, SnO₂, CoO, Co₂O₃, Fe₂O₃, Fe₃O₄, MnO, MnO₂, NiO, Ni₂O₃, H₃BO₃, ZnO, Li₂CO₃, Na₂CO₃, H₃BO₃, NiO, Mg₅ (CO₂)₄(OH)₂·5H₂O, and and MgO. The precursor materials may not comprise a metal oxide, or may comprise ion sources other than oxides. For example, the precursor materials may comprise metal salts (e.g. NO₃⁻, SO₃⁻) or other compounds (e.g. oxalates, carbonates). For the substitution of the oxygen anion with other electronegative anions, the precursors may include one or more organic compounds, polymers, inorganic salts, organic salts, gases, or ammonium salts; examples include but are not limited to: melamine, NH₄HCO₃, NH₃, NH₄F PVDF, PTFE, NH₄Cl, NH₄Br, NH₄I, Br₂, Cl₂, I₂, ammonium oxychloride amide, and hexamethylenetetramine.

When it is desired to make a mixed niobium oxide comprising a cation of a specific oxidation state a precursor comprising that cation at that oxidation state may be selected. For example, when making a mixed niobium oxide comprising Mn²⁺, MnO may be used as the precursor. When making a mixed niobium oxide comprising Mn⁴⁺, MnO₂ may be used as the precursor.

Some or all of the precursor materials may be particulate materials. Where they are particulate materials, preferably they have a D₅₀ particle diameter of less than 20 μm in diameter, for example from 10 nm to 20 μm. Providing particulate materials with such a particle diameter can help to promote more intimate mixing of precursor materials, thereby resulting in more efficient solid-state reaction during the heat treatment step. However, it is not essential that the precursor materials have an initial particle size of <20 μm in diameter, as the particle size of the one or more precursor materials may be mechanically reduced during the step of mixing said precursor materials to form a precursor material mixture.

The step of mixing the precursor materials to form a precursor material mixture and/or further precursor material mixture may be performed by a process selected from: dry or wet/solvated planetary ball milling, rolling ball milling, high energy ball milling, bead milling, pin milling, a classification step, high shear milling, air jet milling, steam jet milling, planetary mixing, powder plending, and/or impact milling. The force used for mixing/milling may depend on the morphology of the precursor materials. For example, where some or all of the precursor materials have larger particle sizes (e.g. a D₅₀ particle diameter of greater than 20 μm), the milling force may be selected to reduce the particle diameter of the precursor materials such that the such that the particle diameter of the precursor material mixture is reduced to 20 μm in diameter or lower. When the particle diameter of particles in the precursor material mixture is 20 μm or less, this can promote a more efficient solid-state reaction of the precursor materials in the precursor material mixture during the heat treatment step. The solid-state synthesis may also be undertaken in pellets formed at high pressure (>10 MPa) from the precursor powders.

The step of heat treating the precursor material mixture and/or the further precursor material mixture may be performed for a time of from 1 hour to 24 hours, more preferably from 3 hours to 18 hours. For example, the heat treatment step may be performed for 1 hour or more, 2 hours or more, 3 hours or more, 6 hours or more, or 12 hours or more. The heat treatment step may be performed for 24 hours or less, 18 hours or less, 16 hours or less, or 12 hours or less.

The step of heat treating the precursor material mixture may be performed in a gaseous atmosphere, preferably air. Suitable gaseous atmospheres include: air, N₂, Ar, He, CO₂, CO, O₂, H₂, NH₃ and mixtures thereof. The gaseous atmosphere may be a reducing atmosphere. Where it is desired to make an oxygen-deficient material, preferably the step of heat treating the precursor material mixture is performed in an inert or reducing atmosphere.

The step of heat treating the further precursor material mixture may be performed under reducing conditions. Reducing conditions include under an inert gas such as nitrogen, helium, argon; or under a mixture of an inert gas and hydrogen; or under vacuum. Preferably, the step of heat treating the further precursor material mixture comprises heating under inert gas.

The further step of heat treating the mixed niobium oxide and/or the mixed niobium oxide comprising additional electronegative anions optionally under reducing conditions may be performed for a time of from 0.5 hour to 24 hours, more preferably from 2 hours to 18 hours. For example, the heat treatment step may be performed for 0.5 hour or more, 1 hours or more, 3 hours or more, 6 hours or more, or 12 hours or more. The further step heat treating may be performed for 24 hours or less, 18 hours or less, 16 hours or less, or 12 hours or less. Reducing conditions include under an inert gas such as nitrogen, helium, argon; or under a mixture of an inert gas and hydrogen; or under vacuum. Preferably heating under reducing conditions comprises heating under inert gas.

In some methods it may be beneficial to perform a two-step heat treatment. For example, the precursor material mixture and/or the further precursor material mixture may be heated at a first temperature for a first length of time, follow by heating at a second temperature for a second length of time. Preferably the second temperature is higher than the first temperature. Performing such a two-step heat treatment may assist the solid-state reaction to form the desired crystal structure. This may be carried out in sequence, or may be carried out with an intermediate re-grinding step.

The method may include one or more post-processing steps after formation of the mixed niobium oxide. In some cases, the method may include a post-processing step of heat treating the mixed niobium oxide, sometimes referred to as ‘annealing’. This post-processing heat treatment step may be performed in a different gaseous atmosphere to the step of heat treating the precursor material mixture to form the mixed niobium oxide. The post-processing heat treatment step may be performed in an inert or reducing gaseous atmosphere. Such a post-processing heat treatment step may be performed at temperatures of above 500° C., for example at about 900° C. Inclusion of a post-processing heat treatment step may be beneficial to e.g. form deficiencies or defects in the mixed niobium oxide, for example to induce oxygen deficiency; or to carry out anion exchange on the formed mixed niobium oxide e.g. N exchange for the O anion.

The method may include a step of milling and/or classifying the mixed niobium oxide (e.g. impact milling, jet milling, steam jet milling, high energy milling, high shear milling, pin milling, air classification, wheel classification, sieving, cyclonic separation, bead milling) to provide a material with any of the particle size parameters given above.

The invention provides a method of making an electrode, the method comprising providing a mixed niobium oxide as defined herein; and depositing the mixed niobium oxide onto a current collector, thereby forming the electrode. Providing the mixed niobium oxide may include synthesising the mixed niobium oxide by the methods provided herein. The depositing step may include forming a slurry of the mixed niobium oxide and a solvent. The slurry may comprise at least one other component selected from a binder, a conductive additive, a different active electrode material, and mixtures thereof. The slurry may be deposited onto a current collector and the solvent removed, thereby forming an electrode layer on the current collector. Further steps, such as heat treatment to cure any binders and/or calendaring of the electrode layer may be carried out as appropriate. For example, the solvent may be removed by drying e.g. at temperatures of 30-100° C. The electrode may be calendared to a density of 2-3.5 or 2.6-2.9 g cm 3. The electrode layer may have a thickness in the range of from 5 μm to 2 mm, preferably 5 μm to 1 mm, preferably 5 μm to 500 μm, preferably 5 μm to 200 μm, preferably 5 μm to 100 μm, preferably 5 μm to 50 μm.

Alternatively, the slurry may be formed into a freestanding film or mat comprising the mixed niobium oxide, for instance by casting the slurry onto a suitable casting template, removing the solvent and then removing the casting template. The resulting film or mat is in the form of a cohesive, freestanding mass which may then be bonded to a current collector by known methods.

### EXAMPLES

The mixed niobium oxides were synthesised by a solid-state route. Appropriate amounts of Nb₂O₅ and precursor materials were mixed and milled, e.g., using a pestle and mortar or impact mill, to form a homogeneous precursor mixture. The resulting mixtures were heat treated in an alumina crucible to high temperatures (>800° C.) for 6-12 h, using a heating rate of between 5-10°/min. The process was repeated until the desired single phase (4×4 Wadsley-Roth block structure) was observed within the X-ray diffraction pattern. Specifically, stoichiometric amounts of precursor materials (Nb₂O₅, Li₂CO₃, Na₂CO₃, H₃BO₃, TiO₂, Al₂O₃, Fe₂O₃, Cr₂O₃, NiO and Mg₅(CO₂)₄ (OH)₂·5H₂O) were mixed and milled either in by hand for 15 mins in a pestle and mortar (ca. 5 g) or using an impact mill at 20,000 rpm for 4 mins (ca. 50 g). The resulting powders were placed in an alumina crucible and heat treated within a muffle furnace in air at T₁=875-1150° C., optionally 900-1150° C., for 6-12 h. A heating rate of 5° C./min was used for all heating steps. An additional milling and heat treatment step T2 was optionally carried out to improve phase purity. Following this, a final milling step was utilised using a pestle and mortar or impact mill for de-agglomeration. The compositions and synthesis parameters are summarised within Table 1.

TABLE 1
Summary of materials synthesised

| | | T1 | T2 | D10 | D50 | D90 |
|---|---|---|---|---|---|---|
| Sample | Composition | (° C.; h) | (° C.; h) | (μm) | (μm) | (μm) |
| 1 | Li₅Nb₉₉O₂₅₀ | 1150; 6 h | 1150; 6 h | 4.1 | 5.9 | 9.1 |
| 2 | Na₅Nb₉₉O₂₅₀ | 900; 12 h | 925: 6 h | 0.9 | 6.4 | 48.2 |
| 3 | B₂Nb₉₈O₂₄₈ | 900; 12 h | 925: 6 h | 0.2 | 3.5 | 7.9 |
| 4 | Li₄Cr₂Nb₉₈O₂₅₀ | 1150; 6 h | 1150; 6 h | 5.2 | 11.5 | 78.2 |
| 5 | Li₄Al₂Nb₉₈O₂₅₀ | 1125; 6 h | 1150; 6 h | 3.5 | 5.8 | 9.2 |
| 6 | Li₄Fe₂Nb₉₈O₂₅₀ | 900; 12 h | 1125: 6 h | 3.1 | 5.2 | 8.6 |
| 7 | Na₂Li₂Fe₂Nb₉₈O₂₅₀ | 900; 12 h | 1125; 6 h | 3.1 | 5.6 | 9.3 |
| 8 | Na₄Cr₂Nb₉₈O₂₅₀ | 900; 12 h | 1100; 6 h | 0.2 | 3.2 | 6.9 |
| 9 | Na₄Fe₂Nb₉₈O₂₅₀ | 900; 12 h | 1100; 6 h | 0.2 | 3.3 | 7.6 |
| 10 | Na₄Ti₄Nb₉₆O₂₅₀ | 900; 12 h | 1100; 6 h | 3.0 | 5.3 | 8.6 |
| 11 | Li₄Ti₄Nb₉₆O₂₅₀ | 900; 12 h | 1125; 6 h | 2.7 | 5.1 | 8.5 |
| 12 | Li₂Na₂Ti₄Nb₉₈O₂₅₀ | 900; 12 h | 1125; 6 h | 2.3 | 5.3 | 9.2 |
| 13 | (Li_{3.75}Na_{0.25})NaNb₉₉O₂₅₀ | 900; 12 h | 1100; 6 h | 2.9 | 5.0 | 8.1 |
| 14 | Na₄Mg_{1.33}Nb_{98.67}O₂₅₀ | 900; 12 h | 1070; 6 h | 1.5 | 4.3 | 7.6 |
| 15 | B_{1.54}Nb_{98.460248}.₄₆ | 825; 12 h | | 0.2 | 3.7 | 9.8 |
| 16 | B₂Tio.₅Wo.₅Nb₉₇O₂₄₈ | 900; 12 h | | 0.2 | 3.9 | 11.4 |
| 17 | B₂Ti_{0.5}Mo_{0.5}Nb₉₇O₂₄₈ | 900; 12 h | | 0.2 | 3.6 | 8.3 |
| 18 | Nb_{98.2}P_{1.8}O₂₅₀ | 925; 6 h | | 0.6 | 5.5 | 44.0 |
| 19 | Nb_{96.4}P_{3.6}O₂₅₀ | 925; 6 h | | 0.2 | 4.5 | 20.9 |
| 20 | Nb_{97.3}P_{2.7}O₂₅₀ | 925; 6 h | | 0.2 | 5.1 | 36.3 |
| 21 | Nb_{96.4}P_{1.8}B_{1.80248}.₂ | 875; 6 h | | 0.3 | 6.1 | 17.9 |
| 22 | Nb_{98.2}P_{1.4}B_{0.4}O_{249.6} | 925; 6 h | | 0.3 | 4.5 | 8.4 |
| 23 | Nb_{94.6}Ti_{1.8}W_{1.8}P_{1.8}O₂₅₀ | 925; 6 h | | 0.2 | 3.8 | 10.3 |
| 24 | Nb_{96.4}W_{2.4}B_{1.2}O₂₅₀ | 925; 6 h | | 0.2 | 3.6 | 10.1 |

### Materials Characterisation

The phase purity of samples was analysed using a Rigaku Miniflex powder X-ray diffractometer in the 2θ range (10-70°) at 1°/min scan rate, or a Bruker D8 Powder diffractometer in the 2θ range 10-50 or 10-60° (step size 0.0189°, time per step 0.42 s).

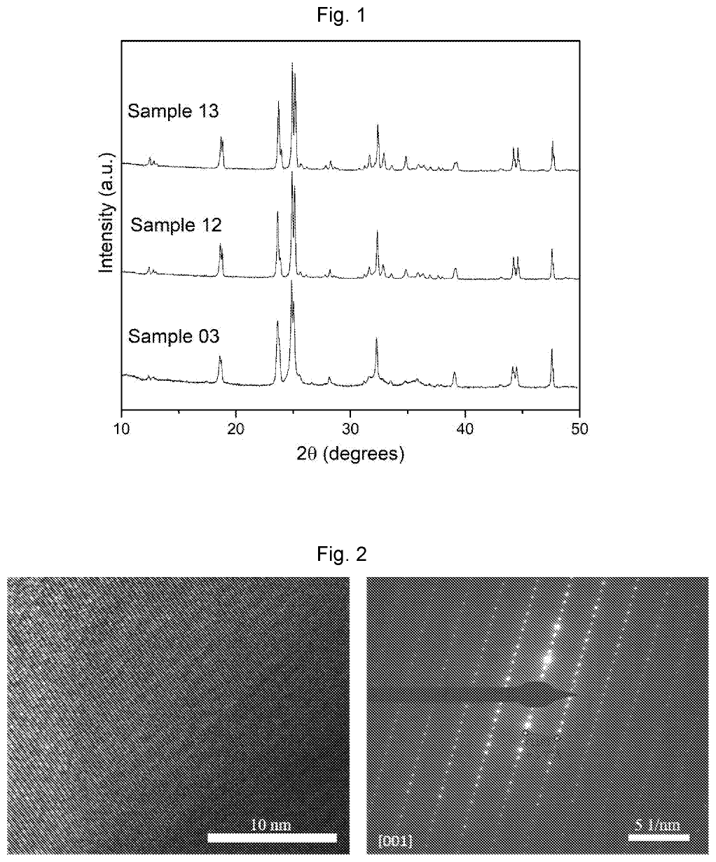

FIGS. 1 and 3 show the measured XRD diffraction patterns for selected Samples. FIG. 2 shows TEM micrographs which show the highly crystalline structure achieved. Table 2 provides unit cell parameters derived from Pawley refinement based on the N—Nb₂O₅ structure.

TABLE 2
Summary of unit cell parameters for samples calculated
from a Pawley refinement within the Topas software.

| Sample | a [Å] | b [Å] | c [Å] | β [°] | Vol [Å³] | χ² |
|---|---|---|---|---|---|---|
| N-Nb₂O₅ reference | 28.51 | 3.830 | 17.48 | 120.80 | | |
| 1 | 28.528 | 3.827 | 17.570 | 125.03 | 1570.87 | 1.9 |
| 3 | 28.538 | 3.824 | 17.561 | 125.07 | 1568.40 | 2.0 |
| 4 | 28.535 | 3.832 | 17.573 | 125.13 | 1571.63 | 1.8 |
| 5 | 28.499 | 3.826 | 17.571 | 125.22 | 1565.29 | 1.7 |
| 6 | 28.492 | 3.823 | 17.558 | 125.06 | 1565.35 | 2.0 |
| 7 | 28.512 | 3.827 | 17.544 | 124.97 | 1568.88 | 1.7 |
| 11 | 28.603 | 3.843 | 17.591 | 124.94 | 1584.98 | 3.1 |
| 12 | 28.616 | 3.844 | 17.592 | 124.92 | 1586.78 | 3.3 |
| 14 | 28.550 | 3.831 | 17.598 | 125.213 | 1572.78 | 2.0 |

### Electrochemical Characterisation

Li-ion cell charge rate is usually expressed as a “C-rate”. A 1C charge rate means a charge current such that the cell is fully charged in 1 h, 10C charge means that the battery is fully charged in 1/10th of an hour (6 minutes). C-rate hereon is defined from the reversible capacity observed of the anode within the voltage limits applied in its second cycle de-lithiation, i.e. for an anode that exhibits 1.0 mAh cm⁻² capacity within the voltage limits of 1.1-3.0 V, a 1C rate corresponds to a current density applied of 1.0 mA cm⁻². In a typical material as described herein, this corresponds to ˜185 mA/g of active material.

Electrochemical tests were carried out in half-coin cells (CR2032 size) for analysis. In half-coin tests, the active material is tested in an electrode versus a Li metal electrode to assess its fundamental performance. In the below examples, the active material composition to be tested was combined with N-Methyl Pyrrolidone (NMP), carbon black (Super P) acting as a conductive additive, and poly(vinyldifluoride) (PVDF) binder and mixed to form a slurry using a lab-scale centrifugal planetary mixer. The non-NMP composition of the slurries was 92 wt % active material, 5 wt % conductive additive, 3 wt % binder. The slurry was coated on an Al foil current collector to the desired loading of 50-100 g m⁻² by doctor blade coating and dried by heating. The electrodes were then calendared to a density of 2.6-2.9 g cm⁻³ at 80° C. to achieve targeted porosities of 35-47%. Electrodes were punched out at the desired size and combined with a separator (Celgard porous PP/PE), Li metal, and electrolyte (1.3 M LiPF₆ in EC/DEC) inside a steel coin cell casing and sealed under pressure. Cycling was then carried out at 25° C. at low current rates (C/10) for 2 full cycles of lithiation and de-lithiation between 1.1-3.0 V. Afterwards, the cells were tested for their performance at increasing current densities. During these tests, the cells were cycled asymmetric at 25° C., with a slow lithiation (C/5) followed by increasing de-lithiation rates (e.g. 1C, 5C, 10C) to provide the capacity retention.

Data has been averaged from 3 to 5 cells prepared from the same electrode coating, with the error shown from the standard deviation. Accordingly, the data represent a robust study showing the improvements achieved by the materials according to the invention compared to prior materials. These data are shown in Tables 3 and 4. Voltage vs. state of charge/discharge curves for samples 1 and 18 are shown in FIG. 4.

Homogeneous, smooth coatings on both Cu and Al current collector foils, the coatings being free of visible defects or aggregates may also be prepared as above for these samples with a centrifugal planetary mixer to a composition of up to 94 wt % active material, 4 wt % conductive additive, 2 wt % binder. These can be prepared with both PVDF (i.e. NMP-based) and CMC: SBR-based (i.e. water-based) binder systems. The coatings can be calendared at 80° C. for PVDF and 50° C. for CMC: SBR to porosities of 35-40% at loadings from 1.0 to 5.0 mAh cm⁻². This is important to demonstrate the viability of these materials in both high energy and high-power applications, with high active material content.

TABLE 3
Performance of the electrodes at C/10 for 2 full cycles
of lithiation and de-lithiation between 1.1-3.0 V

| | | Delithiation specific capacity |
|---|---|---|
| Sample | Composition | 2^{nd} C/10 cycle [mAh/g] |
| 1 | Li₅Nb₉₉O₂₅₀ | 184 ± 5 |
| 2 | Na₅Nb₉₉O₂₅₀ | 197 ± 2 |
| 3 | B₂Nb₉₈O₂₄₈ | 211 ± 6 |
| 4 | Li₄Cr₂Nb₉₈O₂₅₀ | 185 ± 2 |
| 5 | Li₄Al₂Nb₉₈O₂₅₀ | 183 ± 3 |
| 6 | Li₄Fe₂Nb₉₈O₂₅₀ | 166 ± 6 |
| 7 | Na₂Li₂Fe₂Nb₉₈O₂₅₀ | 196 ± 2 |
| 8 | Na₄Cr₂Nb₉₈O₂₅₀ | 197 ± 4 |
| 9 | Na₄Fe₂Nb₉₈O₂₅₀ | 202 ± 3 |
| 10 | Na₄Ti₄Nb₉₆O₂₅₀ | 190 ± 2 |
| 11 | Li₄Ti₄Nb₉₆O₂₅₀ | 189 ± 3 |
| 12 | Li₂Na₂Ti₄Nb₉₈O₂₅₀ | 190 ± 2 |
| 13 | (Li_{3.75}Na_{0.25})NaNb₉₉O₂₅₀ | 198 ± 3 |
| 14 | Na₄Mg_{1.33}Nb_{98.67}O₂₅₀ | 191 ± 3 |
| 15 | B_{1.54}Nb_{98.46}O_{248.46} | 215 ± 3 |
| 16 | B₂Ti_{0.5}W_{0.5}Nb₉₇O₂₄₈ | 217 ± 6 |
| 17 | B₂Ti_{0.5}Mo_{0.5}Nb₉₇O₂₄₈ | 230 ± 5 |
| 18 | Nb_{98.2}P_{1.8}O₂₅₀ | 228 ± 4 |
| 19 | Nb_{96.4}P_{3.6}O₂₅₀ | 227 ± 2 |
| 20 | Nb_{97.3}P_{2.7}O₂₅₀ | 221 ± 6 |
| 21 | Nb_{96.4}P_{1.8}B_{1.8}O_{248.2} | 208 ± 3 |
| 22 | Nb_{98.2}P_{1.4}B_{0.4}O_{249.6} | 216 ± 3 |
| 23 | Nb_{94.6}Ti_{1.8}W_{1.8}P_{1.8}O₂₅₀ | 209 ± 2 |
| 24 | Nb_{96.4}W_{2.4}B_{1.2}O₂₅₀ | 213 ± 2 |

TABLE 4
Performance of the electrodes at increasing current densities

| | | Delithiation | Delithiation | Delithiation | Delithiation |
|---|---|---|---|---|---|
| | | specific capacity | specific capacity | specific capacity | specific capacity |
| Sample | Composition | 0.5 C [mAh/g] | 1 C [mAh/g] | 5 C [mAh/g] | 10 C [mAh/g] |
| 1 | Li₅Nb₉₉O₂₅₀ | 172 ± 2 | 174 ± 4 | 174 ± 3 | 172 ± 1 |
| 2 | Na₅Nb₉₉O₂₅₀ | 186 ± 2 | 178 ± 1 | 145 ± 3 | 113 ± 4 |
| 3 | B₂Nb₉₈O₂₄₈ | 206 ± 1 | 204 ± 1 | 200 ± 3 | 190 ± 8 |
| 4 | Li₄Cr₂Nb₉₈O₂₅₀ | 173 ± 4 | 173 ± 1 | 170 ± 1 | 169 ± 1 |
| 5 | Li₄Al₂Nb₉₈O₂₅₀ | 174 ± 3 | 174 ± 3 | 173 ± 3 | 173 ± 3 |
| 6 | Li₄Fe₂Nb₉₈O₂₅₀ | 158 ± 3 | 158 ± 4 | 157 ± 6 | 158 ± 7 |
| 7 | Na₂Li₂Fe₂Nb₉₈O₂₅₀ | 177 ± 1 | 175 ± 2 | 172 ± 2 | 169 ± 2 |
| 8 | Na₄Cr₂Nb₉₈O₂₅₀ | 195 ± 1 | 195 ± 1 | 189 ± 2 | 183 ± 7 |
| 9 | Na₄Fe₂Nb₉₈O₂₅₀ | 194 ± 1 | 192 ± 1 | 190 ± 1 | 186 ± 2 |
| 10 | Na₄Ti₄Nb₉₆O₂₅₀ | 176 ± 8 | 178 ± 2 | 177 ± 1 | 173 ± 3 |
| 11 | Li₄Ti₄Nb₉₆O₂₅₀ | 179 ± 3 | 180 ± 3 | 181 ± 4 | 175 ± 4 |
| 12 | Li₂Na₂Ti₄Nb₉₈O₂₅₀ | 181 ± 2 | 180 ± 1 | 176 ± 1 | 172 ± 3 |
| 13 | (Li_{3.75}Na_{0.25})NaNb₉₉O₂₅₀ | 186 ± 1 | 185 ± 1 | 184 ± 2 | 183 ± 1 |
| 14 | Na₄Mg_{1.33}Nb_{98.67}O₂₅₀ | 188 ± 3 | 188 ± 3 | 185 ± 5 | 181 ± 7 |
| 15 | B_{1.5}Nb₉₈O_{247.25} | 207 ± 2 | 207 ± 3 | 204 ± 3 | 197 ± 4 |
| 16 | B₂Ti_{0.5}W_{0.5}Nb₉₇O_{246.5} | 209 ± 3 | 208 ± 2 | 201 ± 4 | 192 ± 6 |
| 17 | B₂Ti_{0.5}Mo_{0.5}Nb₉₇O_{246.5} | 218 ± 1 | 215 ± 1 | 207 ± 2 | 195 ± 5 |
| 18 | Nb_{98.2}P_{1.8}O₂₅₀ | 217 ± 7 | 214 ± 6 | 204 ± 4 | 193 ± 4 |
| 19 | Nb_{96.4}P_{3.6}O₂₅₀ | 211 ± 2 | 210 ± 2 | 192 ± 2 | 169 ± 6 |
| 20 | Nb_{97.3}P_{2.7}O₂₅₀ | 210 ± 6 | 210 ± 8 | 198 ± 4 | 185 ± 1 |
| 21 | Nb_{96.4}P_{1.8}B_{1.8}O_{248.2} | 203 ± 2 | 201 ± 2 | 198 ± 2 | 191 ± 1 |
| 22 | Nb_{98.2}P_{1.4}B_{0.4}O_{249.6} | 206 ± 3 | 204 ± 2 | 188 ± 2 | 154 ± 7 |
| 23 | Nb_{94.6}Ti_{1.8}W_{1.8}P_{1.8}O₂₅₀ | 205 ± 1 | 202 ± 1 | 192 ± 1 | 185 ± 2 |
| 24 | Nb_{96.4}W_{2.4}B_{1.2}O₂₅₀ | 203 ± 5 | 202 ± 4 | 198 ± 3 | 192 ± 4 |

### DISCUSSION

The mixed niobium oxides according to the invention were found to exhibit remarkable properties at high de-lithiation rates of e.g. 5C and 10C. In particular, in some cases, the specific capacity at lower rates is largely retained at high rates, e.g. with the capacity at 10C being 97.7% or greater of the capacity at 0.5C; an exceptionally high capacity retention. These are important results in demonstrating the advantages of the mixed niobium oxides of the invention for use in high-power batteries designed for fast charge/discharge.

1. An electrode comprising a mixed niobium oxide as an active electrode material, wherein the electrode is of the form of an electrode composition in electrical contact with a current collector, where the electrode composition comprises the mixed niobium oxide, wherein the mixed niobium oxide has the formula M^{I}ₓ₋ᵤM^{y}_{(x/(5-y))} M^{V}_{z}Nb_{100-(x/(5-y))-z}O_{250-u/2}, wherein:
M^{I} is a cation having an oxidation state of 1, wherein M^{I} is selected from Li, Na, K, and mixtures thereof;
M^{y} is a cation having an average oxidation state of y, wherein M^{y} is selected from Li, Na, K, Cu, Zn, Mg, Ca, Ni, Fe, Mn, Co, Cr, V, Al, B, Ga, Sc, Y, In, La, Yb, Ce, Zr, Ti, Sn, Ge, Si, P, Ta, W, Mo, and mixtures thereof;
M^{V} is a cation having an average oxidation state of 5, wherein M^{V} is selected from Mn, Fe, Al, Ga, Y, In, La, Yb, Cu, Zn, Mg, Ni, Co, Ca, Ce, Zr, Ti, Sn, Ge, Si, V, P, Ta, W, Mo, Cr, and mixtures thereof;
$$\begin{matrix}1 \leq y \leq 4 ; \\ 0.5 \leq x \leq 6 ; \\ 0 \leq z \leq 10 ; \\ 0 \leq u \leq 5 ; \\ x > u .\end{matrix}$$

2. The electrode according to claim 1, wherein
M^{y} is selected from Li, Na, Cu, Zn, Mg, Ni, Fe, Mn, Co, Cr, Al, B, Ga, Zr, Ti, and mixtures thereof.

3. The electrode according to claim 1, wherein:
y is 1, 2, 3, or 4.

4. The electrode according to claim 1, wherein all cations forming M^{y} have the same oxidation state.

5. (canceled)

6. The electrode according to claim 1, wherein the mixed niobium oxide has the formula
M^{I}ₓ₋ᵤN^{I}_{x/4}M^{V}_{z}Nb_{100-x/4-z}O_{250-u/2}, wherein:
N^{I} is a cation having an oxidation state of 1.

7. (canceled)

8. The electrode according to claim 1, wherein the mixed niobium oxide has the formula
M^{I}ₓ₋ᵤM^{II}_{x/3}M^{V}_{z}Nb_{100-x/3-z}O_{250-u/2}, wherein:
M^{II} is a cation having an average oxidation state of 2.

9. The electrode according to claim 8, wherein all cations forming M^{II} have an oxidation state of 2.

10. The electrode according to claim 8, wherein:
M^{II} is selected from Cu, Zn, Mg, Ni, Fe, Mn, Co, Ca, and mixtures thereof.

11. The electrode according to claim 1, wherein the mixed niobium oxide has the formula
M^{I}ₓ₋ᵤM^{III}_{x/2}M^{V}_{z}Nb_{100-x/2-z}O_{250-u/2}, wherein:
M^{III} is a cation having an average oxidation state of 3.

12. The electrode according to claim 11, wherein all cations forming M^{III} have an oxidation state of 3.

13. The electrode according to claim 11, wherein:
M^{III} is selected from Mn, Cr, V, Fe, Al, B, Ga, Y, In, La, Yb, Ce, and mixtures thereof.

14. The electrode according to claim 1, wherein the mixed niobium oxide has the formula
M^{I}ₓ₋ᵤM^{IV}ₓM^{V}_{z}Nb_{100-x-z}O_{250-u/2}, wherein:
M^{IV} is a cation having an average oxidation state of 4.

15. The electrode according to claim 14, wherein all cations forming M^{IV} have an oxidation state of 4.

16. The electrode according to claim 14, wherein:
M^{IV} is selected from Zr, Ti, Mn, Ce, Sn, Ge, V, Si, and mixtures thereof.

17. The electrode according to claim 1, wherein:
x is 1, 2, 3, 4, 5, or 6.

18. The electrode according to claim 1, wherein:
u=0.

19. The electrode according to claim 1, wherein x≥ u+1.

20. The electrode according to claim 1, wherein the mixed niobium oxide only contains Li if a further cation other than Li and Nb is present.

21. The electrode according to claim 1, wherein M^{y} does not contain Li, or wherein the mixed niobium oxide does not contain Li.

22. An electrode comprising a mixed niobium oxide as an active electrode material, wherein the mixed niobium oxide has the formula BₐM^{v}_{z}Nb_{100-a-z}O₂₅₀₋ₐ, wherein
M^{V} is a cation having an average oxidation state of 5, wherein M^{V} is selected from Mn, Fe, Al, Ga, Y, In, La, Yb, Cu, Zn, Mg, Ni, Co, Ca, Ce, Zr, Ti, Sn, Ge, Si, V, P, Ta, W, Mo, Cr, and mixtures thereof;
$$0 \leq z \leq 10 ;$$
$$0 < a \leq 8 .$$

23. The electrode according to claim 22, wherein:
$$1 \leq a \leq 5$$

24. The electrode according to claim 1, wherein:
M^{V} is selected from Ce, Zr, Ti, Sn, Ge, Si, V, P, Ta, W, Mo, Cr, and mixtures thereof.

25. The electrode according to claim 1, wherein all cations forming M^{V} have an oxidation state of 5.

26. The electrode according to claim 1, wherein:
$$0 \leq z \leq 5$$

27. An electrode comprising a mixed niobium oxide as an active electrode material, wherein the mixed niobium oxide has the formula M_{b}Nb_{100-b}O_{250-2.5b+bc}, wherein
M is a cation selected from P, B, W, Mo, V, Ti, Si, and mixtures thereof;
c is half of the average oxidation state of M;
$$1.5 \leq c \leq 3 ; and$$
$$0.5 < b \leq 6 .$$

28. The electrode according to claim 27, wherein the most intense peak between 18.15-18.65° 2θ has a full width half maximum of >0.2 in the X-ray diffraction pattern of the material with a CuKα source.

29. (canceled)

30. The electrode according to claim 1, wherein the cations are partially substituted by cations of different oxidation state.

31. The electrode according to claim 1, wherein the oxygen anions are partially substituted by an electronegative anion selected from F, Cl, Br, S, Se, N, and mixtures thereof.

32. The electrode according to claim 1, wherein the mixed niobium oxide has a D₅₀ particle diameter in the range of 0.1-100 μm, or 0.5-50 μm, or 1-20 μm.

33. The electrode according to claim 1, wherein the mixed niobium oxide a BET surface area in the range of 0.1-100 m²/g, or 0.2-50 m²/g, or 0.5-20 m²/g.

34-35. (canceled)

36. The electrode according to claim 1, wherein the mixed niobium oxide has a Wadsley-Roth block structure comprising 4×4 octahedral blocks.

37. The electrode according to claim 1, wherein the mixed niobium oxide has a monoclinic crystal structure having unit cell parameters
a=25.7-31.4 Å, b=3.4-4.2 Å, c=15.8-19.3 Å, α=90°, B=112.6-137.6°, γ=90°.

38. The electrode according to claim 1, wherein the crystal structure of the mixed niobium oxide corresponds to the crystal structure of N—Nb₂O₅.

39. The electrode according to claim 1, wherein the mixed niobium oxide forms at least 5 wt. %, 10 wt. %, or 50 wt. % of the total active electrode material in the electrode; or wherein the mixed niobium oxide is the sole active electrode material in the electrode.

40-41. (canceled)

42. A metal-ion battery comprising the electrode of claim 1.

43. The metal-ion battery according to claim 42, which is a lithium-ion battery having a reversible anode active material specific capacity of greater than 180 mAh/g at 20 mA/g, wherein the battery can be charged and discharged at current densities relative to the anode active material of 200 mA/g or more, or 1000 mA/g or more, or 2000 mA/g or more, or 4000 mA/g or more whilst retaining greater than 70% of the initial cell capacity at 20 mA/g.

44-46. (canceled)

47. The electrode according to claim 22, wherein the mixed niobium oxide has a Wadsley-Roth block structure comprising 4×4 octahedral blocks.

48. The electrode according to claim 27, wherein the mixed niobium oxide has a Wadsley-Roth block structure comprising 4×4 octahedral blocks.
